(19) United States
(12) Patent Application Publication
(10) Pub. No.: US 2014/0335256 A1
(43) Pub. Date: Nov. 13, 2014

(54) HEAT-TREATMENT OF MILK

(71) Applicant: Eileen McKillop, Bothell, WA (US)

(72) Inventor: Eileen McKillop, Bothell, WA (US)

(21) Appl. No.: 13/889,336

(22) Filed: May 7, 2013

(51) Int. Cl. A23C 3/02

(52) U.S. Cl. CPC A23C 3/02
USPC 426/580; 426/522

(57) ABSTRACT

Described herein are systems and methods for the heat treatment of milk, particularly bovine milk. The heat treatment changes the color and flavor of the milk, as well as denatures some of the milk proteins therein. These changes can provide a milk that is less likely to cause allergic reactions in consumers of the heat treated milk and products made from such milk.

### BACKGROUND

Milk is a food considered essential to many cultures and ways of life. Many people consume milk from animals, particularly cows. However, people may experience adverse reactions to bacteria, proteins, enzymes, and other components in raw, or even pasteurized, milk. Milk products may have the fat content altered or sugars, such as lactose, removed to help people consume milk and milk products without incident. For those with allergies to proteins or sensitivities to other components, milk substitutes, such as soy and nut “milks”, are alternatives to consuming milk from cows, sheep, goats, and other domesticated animals.

The heat-treating methods described herein produce a heat-treated, or baked, milk that is free of harmful bacteria and enzymes, has improved organoleptic characteristics, and has increased stability during storage.

### SUMMARY

Provided herein are methods and systems for the heat-treatment of milk. The heat-treated, or baked, milk has different coloring and flavor from raw or merely pasteurized milk. Heat-treatment also can denature some of the proteins in the milk, to provide milk that is less likely to cause allergic reactions in people who drink the heat-treated milk or consume product made from such milk.

In some implementations, a method for heat-treating milk is provided. The method includes heating pasteurized milk to an elevated temperature of about 95-99° C. for an extended period of time to yield heat-treated milk.

The method can include any of the following features in any suitable combination. The method can further include sterilizing the heat-treated milk by heating the milk to a first temperature of approximately 137° C. for a period of time up to 4 seconds, and then cooling the heat-treated milk to a second temperature at or below 20° C. In some implementations, the method can further include testing the heat-treated milk for heat stability. In such implementations, the method can further include adding salt, stabilizers, or both salt and stabilizers after testing the heat-treated milk for heat stability. Other implementations of the method can further include processing the heat-treated milk to form a milk-product. In such implementations, the milk product can include: cottage cheese, yogurt, condensed milk, or any other dairy product. In the method, the extended period of time can be at least 3 hours. In some implementations of the method, an end to the extended period of time can be determined by measurements and observations made regarding the milk's temperature, viscosity, color, proteins, sugars, and enzymes.

In a related aspect, a system for heat-treating milk is provided. The system can include a milk pasteurization station and a high temperature, long time, milk treatment station configured to accept pasteurized milk from the milk pasteurization station and generate heat-treated milk.

The following features can be combined in any suitable way in some implementations of the system described above. In some implementations, the high temperature, long time, milk treatment station can be configured to heat pasteurized milk at a temperature of about 95 to 99° C. for an extended period of time. In such implementations, the extended period of time can be at least 3 hours. Also, the extended period of time can be determined by measurements and observations made regarding the milk's temperature, viscosity, color, proteins, sugars, and enzymes by sensors in the high temperature, long time milk treatment station. In some implementations, the high temperature, long time milk treatment station can include temperature sensors, pressure sensors, and analytical equipment that can determine the amount or presence of proteins and enzymes.

Further, in a related aspect, a composition that includes denatured casein and whey proteins is provided. The composition also has similar nutritional value to that of raw milk or pasteurized milk. Additionally, the composition can further include a creamy color and caramel-like flavor.

### BRIEF DESCRIPTION OF THE DRAWINGS

FIG. 1 shows an exemplary method for heat-treating milk; and

FIG. 2 shows an exemplary system for handling milk, including heat-treating milk.

### DETAILED DESCRIPTION

Milk from domesticated animals, particularly cows, is widely consumed in various parts of the world. The milk is often purified and treated to prevent diseases, deter spoilage, and allow for easier digestion, in some cases. The heat-treatment described herein differs from pasteurization because the milk is exposed to a higher temperature for a longer period of time, resulting in a heat-treated, or baked, milk that is creamy in color and has a caramel-like flavor. The heat-treatment causes the sugar in the milk to react with amino acids and proteins to form melanoidins that impart the creamy color and caramel flavor to heat-treated milk. These flavor and color changes occur because there is a corresponding change in amino acids with the formation of sulfide groups that interact with components of the milk. Heat-treated milk, as treated by the process further described below, is free of harmful bacteria and enzymes and has improved storage-stability and organoleptic characteristics, as compared to milk that is only pasteurized.

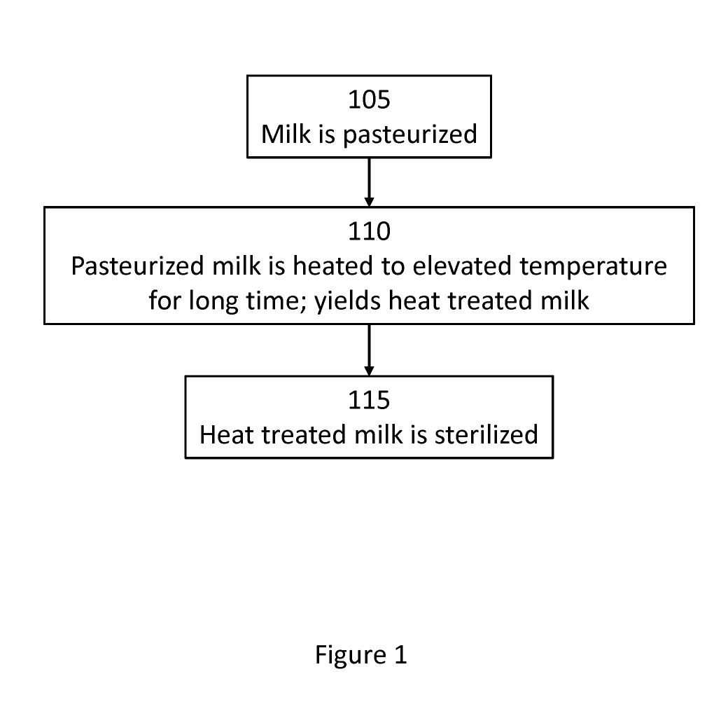

FIG. 1 shows an exemplary method for heat-treating milk. In this exemplary implementation of a method for heat-treating milk, milk is first pasteurized, as shown in 105. In this some implementations, standard HTST (high temperature, short time) pasteurization is used to kill microorganisms in the milk. HTST pasteurization heats milk to approximately 72-75° C. for 15-20 seconds before the milk is cooled.

Following pasteurization, the milk is elevated to a temperature ranging from approximately 95 to 99° C. for a relatively long period of time, as shown in 110 of FIG. 1. This application of heat to obtain specific temperatures for particular time periods or until the milk exhibits certain characteristics corresponds to a heating profile. The heating profile can include heating pasteurized milk in an industrial container to a temperature of approximately 95-99° C. for a time period of at least 3 hours, such as 3 to 4 hours. Occasionally the milk is stirred for periods of 2 to 3 minutes. Stirring helps to prevent the formation of a creamy substance consisting of protein and fat on the surface of the milk during heat-treatment.

During heating, various characteristics of the milk can be observed to help determine when the end of the elevated temperature portion of the heating profile has been reached. Measurements and observations can be made regarding the milk's temperature, viscosity, color, proteins, sugars, and enzymes. Proteins that can be monitored include casein and whey. Sugars that can be monitored include lactose.

When the end of the elevated temperature time period is reached, the milk is cooled to 75° C. After cooling and before sterilization, the heat-treated milk undergoes a heat stability test that determines whether salt, stabilizers, or other both salt and stabilizers should be added.

The heating profile can vary in temperature, such that an elevated temperature outside of the 95-99° C. range can be used. Generally, the elevated temperature can be higher than the temperature used for HTST pasteurization. When the elevated temperature varies, the time period during which the milk is heated at the elevated temperature can also vary. Variations in temperature can occur because of the limitations of the equipment available, such as the inability to maintain or retain heat due to insulation or size factors. Pressure variations can also influence changes in the elevated temperature used or the time period during which the milk is at the elevated temperature. The time period that the milk is at the elevated temperature can range from 3 hours to 15 hours or more.

Once the milk has undergone treatment at elevated temperature for the extended period of time, it is cooled and then sterilized, as shown in 115 of FIG. 1. The milk can be homogenous when beginning the sterilization process. The sterilization process can include heating the milk to approximately 137° C. for not more than 4 seconds. The heated milk cools to a temperature not exceeding 20° C. in equipment that maintains sterility while removing heat.

After sterilization, the heat-treated milk can be packaged, under sterile conditions, for consumption. Alternatively, the heat-treated milk can be used to create other dairy products, such as cottage cheese, yogurt, condensed milk, ice cream and the like.

A consumer can purchase heat-treated milk in the refrigerated aisle, where heat-treated milk can be found next to pasteurized milk, lactose-free milk, and other diary products. The consumer can use heat-treated milk for the same purposes as pasteurized milk or lactose-free milk. Uses include, but are not limited to, for breakfast cereal, for drinking, for adding to drinks, for making ice cream, for making yogurt, for baking, for making cheese, and the like. The consumer, if he or she has allergies or other adverse reactions to components of pasteurized milk, can find that his or her adverse reactions occur to a lesser degree when using heat-treated milk.

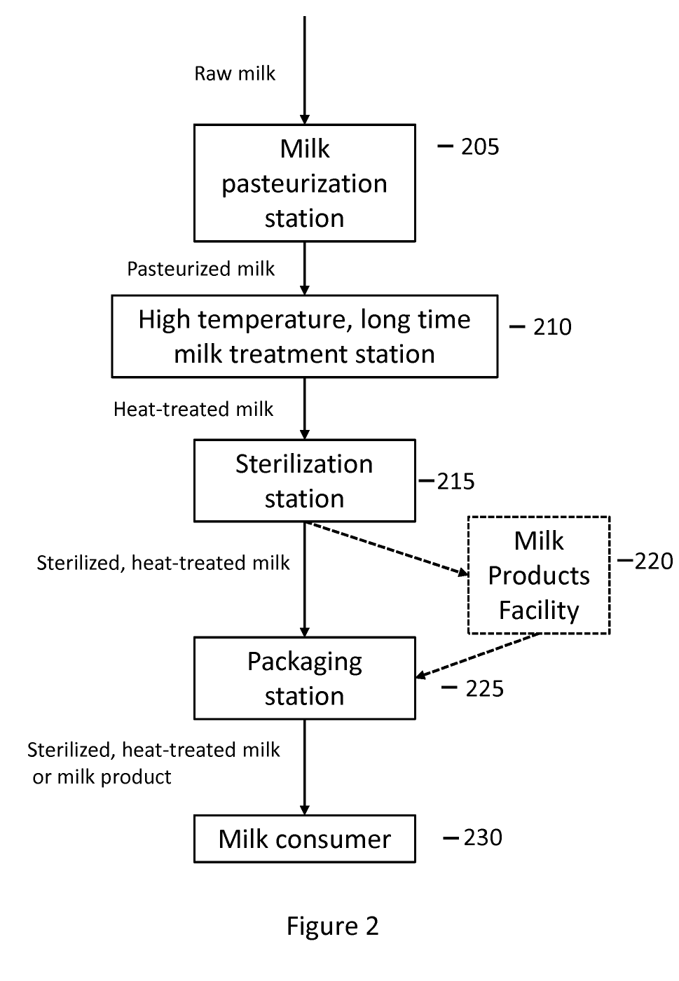

FIG. 2 shows a schematic view of an exemplary system for heat-treating milk. The system includes a milk pasteurization station 205; a high temperature, long time, milk treatment station 210; a sterilization station 215; and a packaging station 225. Optionally, the system includes a milk products facility 220, and the system can include a milk consumer 230.

In the system, raw milk, obtained from an animal, such as a cow or goat, is provided to a milk pasteurization station 205. Once pasteurized, the milk passes to the high temperature, long time, milk treatment station 210.

The milk pasteurization station 205 uses any suitable technique, including standard pasteurization techniques, either HTST (high temperature, short time) or UHT (ultra-high temperature), to kill or destroy many illness-creating bacteria and other pathogens. In some implementations, irradiation can be used to destroy micoorganisms in the milk pasteurization station 205. The milk pasteurization station 205 can include industrial-sized or industrial-grade equipment to pasteurize milk, whether using temperature or radiation.

In the high temperature, long time, milk treatment station 210, pasteurized milk is treated according the heating profile described above. This heating profile can include heating pasteurized milk in an industrial container to a temperature of approximately 95-99° C. for a time period of 3 to 4 hours. Occasionally components within the high temperature, long time, milk treatment station 210 stir the milk for periods of 2 to 3 minutes. The high temperature, long time, milk treatment station 210 can include sensors to help determine when the end of the elevated temperature portion of the heating profile has been reached. Such sensors can include temperature sensors, pressure sensors, viscosity sensors, color sensors, density sensors, sugar content sensors, and analytical equipment that can determine the amount or presence of proteins and enzymes. Temperature sensors can include infra-red (IR) temperature sensors, thermocouples, and the like.

The high temperature, long time, milk treatment station 210 can include a cooling station where the milk is cooled prior to sterilization. The cooling station can also be where testing for heat stability takes place, as well as where salt, stabilizers, or both salt and stabilizers are added.

The heat-treated milk passes to the sterilization station 215 where it reaches a temperature of approximately 137° C. for a very short time (up to 4 seconds) and then is cooled to a temperature at or below 20° C. The sterilization station 215 includes equipment to heat the milk to the required temperature, then maintain sterile conditions while cooling the milk. The sterile cooling equipment can include an apparatus that creates a stream of sterilized milk in an aseptic milk line. The aseptic milk line connects to an aseptic tank. The aseptic tank can accept purified, sterile air to help move the sterilized, heat-treated milk for packaging at the packaging station 225 or further processing at the milk products facility 220.

When sterilized, heat-treated milk passes to the milk products facility 220, it can be used to make dairy products such as cottage cheese, condensed milk, yogurt, ice cream, other food products that list milk as their main ingredient, and the like. These dairy products can be less likely to cause adverse reactions in persons with milk allergies or sensitivities. The dairy products can then pass to the packaging station 225.

The milk consumer 230 can receive either sterilized, heat-treated milk for direct consumption (i.e. drinking) or home use, or the milk consumer 230 can receive a milk product, such as cheese. Fewer or less severe adverse reactions to the milk or milk product can occur. The milk consumer 230 can also enjoy the extended life-time, richer flavor, and unique color of the sterilized, heat-treated milk without concern for degradation in nutritional value as compared to raw or merely pasteurized milk.

The resulting sterilized, heat-treated milk causes the food proteins, such as casein and whey, to break down, reducing the allergenicity to the point that persons with an adverse immune reaction to such food proteins can experience less severe or less frequent reactions. Also, increased exposure to heat-treated, or baked, milk products in children accelerates the rate at which children outgrow milk allergies. Similarly, persons sensitive to sugars present in milk, such as lactose, can have reduced sensitivity to heat-treated milk, as compared to raw or pasteurized-only milk, because the sugars will have reacted with other components in the milk during the elevated temperature portion of the heating profile to impart the color and flavor changes in the resulting heat-treated milk.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Although embodiments of various methods and devices are described herein in detail with reference to certain versions, it should be appreciated that other versions, methods of use, embodiments, and combinations thereof are also possible. Therefore the spirit and scope of the appended claims should not be limited to the description of the embodiments contained herein.

What is claimed is:

1. A method for heat-treating milk, comprising:
heating pasteurized milk to an elevated temperature of about 95-99° C. for an extended period of time to yield heat-treated milk.

2. The method of claim 1, further comprising sterilizing the heat-treated milk by heating the milk to a first temperature of approximately 137° C. for a period of time up to 4 seconds and then cooling the heat-treated milk to a second temperature at or below 20° C.

3. The method of claim 1, further comprising testing the heat-treated milk for heat stability.

4. The method of claim 3, further comprising adding salt, stabilizers, or both salt and stabilizers after testing the heat-treated milk for heat stability.

5. The method of claim 1, further comprising processing the heat-treated milk to form a milk product.

6. The method of claim 5, wherein the milk product comprises: cottage cheese, yogurt, condensed milk, or any other dairy product.

7. The method of claim 1, wherein the extended period of time is at least 3 hours.

8. The method of claim 1, wherein an end to the extended period of time is determined by measurements and observations made regarding the milk's temperature, viscosity, color, proteins, sugars, and enzymes.

9. A system for heat-treating milk, comprising:
a milk pasteurization station configured to accept raw milk and generate pasteurized milk; and
a high temperature, long time milk treatment station configured to accept pasteurized milk from the milk pasteurization station and generate heat-treated milk.

10. The system of claim 9, wherein the high temperature, long time milk treatment station is configured to heat pasteurized milk at a temperature about 95 to 99° C. for an extended period of time.

11. The system of claim 10, wherein the extended period of time is at least 3 hours.

12. The system of claim 10, wherein the extended period of time is determined by measurements and observations made regarding the milk's temperature, viscosity, color, proteins, sugars, and enzymes by sensors in the high temperature, long time milk treatment station.

13. The system of claim 9, wherein the high temperature, long time milk treatment station comprises temperature sensors, pressure sensors, viscosity sensors, color sensors, density sensors, sugar content sensors, and analytical equipment that can determine the amount or presence of proteins and enzymes.

14. A composition, comprising denatured casein and whey proteins, and further comprising similar nutritional value to that of raw milk or pasteurized milk.

15. The composition of claim 14, further comprising a creamy color and caramel-like flavor.
